(19) United States
(12) Patent Application Publication
(10) Pub. No.: US 2013/0124504 A1
(43) Pub. Date: May 16, 2013

(54) Sharing Digital Content to Discovered Content Streams in Social Networking Services

(71) Applicants: Frances B. Haugen, Mountain View, CA (US); Daniel M. Crichton, Eden Prairie, MN (US); Joseph M. Rozier, San Jose, CA (US); Gregory M. Marra, San Francisco, CA (US)

(72) Inventors: Frances B. Haugen, Mountain View, CA (US); Daniel M. Crichton, Eden Prairie, MN (US); Joseph M. Rozier, San Jose, CA (US); Gregory M. Marra, San Francisco, CA (US)

(73) Assignee: Google Inc.

(21) Appl. No.: 13/676,372

(22) Filed: Nov. 14, 2012

Related U.S. Application Data
(60) Provisional application No. 61/559,547, filed on Nov. 14, 2011.
(60) Provisional application No. 61/559,564, filed on Nov. 14, 2011.
(60) Provisional application No. 61/559,559, filed on Nov. 14, 2011.
(60) Provisional application No. 61/559,575, filed on Nov. 14, 2011.

(51) Int. Cl. G06F 17/30

(52) U.S. Cl. 707/722; 707/E17.014; 707/E17.032

(57) ABSTRACT

Methods, systems, and apparatus, including computer programs encoded on a computer storage medium, for receiving a query for content within a user interface of a social networking service, obtaining search results based on the query, the search results including a set of items distributed by users of the social networking service, transmitting instructions to display the search results in a search stream provided in the user interface, the set of items being included in the search stream, receiving first user input, the first user input defining an item data set associated with an item to be provided in the search results, and transmitting instructions to display revised search results including the item in one or more search streams, the one or more search streams including the search stream.

### CROSS-REFERENCE TO RELATED APPLICATIONS

This application claims the benefit of U.S. Provisional App. Nos. 61/559,547, 61/559,564, 61/559,559, and 61/559,575, filed on Nov. 14, 2011, the disclosures of which are expressly incorporated herein by reference in the entirety.

### BACKGROUND

Internet-based social networking services provide a digital medium for users to interact with one another and share information. For examples, users are able to distribute digital content (e.g., textual comments, digital images, digital videos, digital audio, hyperlinks to websites, etc.) to other users that they might be connected with in the social networking service. Digital content that is distributed to a user can be displayed to the user in a stream page.

As a user's social network within the social networking service increases, the amount of digital content distributed to the user and the amount of digital content that the user interacts with can increase, which can include digital content that might not be relevant to the user and/or digital content that might be of low quality (e.g., spam).

### SUMMARY

This specification generally relates to displaying content distributed by users in a social networking service.

In general, innovative aspects of the subject matter described in this disclosure may be embodied in methods that include the actions of receiving a query for content within a user interface of a social networking service, obtaining search results based on the query, the search results including a set of items distributed by users of the social networking service, transmitting instructions to display the search results in a search stream provided in the user interface, the set of items being included in the search stream, receiving first user input, the first user input defining an item data set associated with an item to be provided in the search results, and transmitting instructions to display revised search results including the item in one or more search streams, the one or more search streams including the search stream. Other implementations of this aspect include corresponding systems, apparatus, and computer programs, configured to perform the actions of the methods, encoded on computer storage devices.

These and other implementations may each optionally include one or more of the following features. For instance, actions further include providing source indication data in the item data set, the source indication data indicating that the item was shared directly to the search stream; actions further include: receiving a second query for content, generating second search results based on the second query, the search results identifying the set of items distributed by users of the social networking service, determining, based on the source indication data, that the item is to be included in the second search results, and transmitting instructions to display the second search results in the search stream, the set of items and the item being included in the search stream; generating search results based on the query includes: identifying a first set of items based on the query, for each item in the first set of items, determining whether a user that submitted the query is authorized access, and identifying a second set of items, the second set of items including the set of items, the user being authorized access to each of the set of items, the search results including the second set of items; for each item in the first set of items, determining whether the user that submitted the query is authorized access includes, for each item in the first set of items, determining whether the user is identified in an associated access control list (ACL); the search stream is displayed to a user that submitted the query, and transmitting instructions to display revised search results including the item in one or more search streams includes displaying the revised search results in a second search stream associated with a second user; and the revised search results are provided in real-time without requiring a user request for the revised search results.

In general, innovative aspects of the subject matter described in this disclosure may be embodied in methods that include the actions of transmitting instructions to display search results in a search stream provided in a user interface of a social networking service, the search results comprising a set of items including one or more items, receiving user input, the user input defining an item data set associated with an item to be distributed using the social networking service, the item including a representation of the set of items, and distributing the item for display to one or more users of the social networking service. Other implementations of this aspect include corresponding systems, apparatus, and computer programs, configured to perform the actions of the methods, encoded on computer storage devices.

These and other implementations may each optionally include one or more of the following features. For instance, the item includes a summary of the search stream; the item includes a link that can be activated to display the search stream to a user of the one or more users; the item data set includes a distribution, the one or more users being identified in the distribution; actions further includes: receiving a request to share the search stream, and in response to receiving the request, transmitting instructions to display a search stream sharing interface, the user input being provided using the search stream sharing interface; actions further include, in response to receiving the request, identifying search stream summary data, the search stream summary data being displayed in the search stream sharing interface; actions further include: receiving a query for content within a user interface of the social networking service, and generating the search results based on the query; generating search results based on the query includes: identifying a first set of items based on the query, for each item in the first set of items, determining whether a user that submitted the query is authorized access, and identifying a second set of items, the second set of items including the set of items, the user being authorized access to each item of the set of items, the search results comprising the second set of items; for each item in the first set of items, determining whether the user that submitted the query is authorized access includes, for each item in the first set of items, determining whether the user is identified in an associated access control list (ACL); and the set of items include one or more items distributed by users of the social networking service.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a diagram of an example network architecture.

FIG. 2 is a diagram of an example social network including social circles.

FIG. 3 depicts a screen-shot of an example graphical user interface for creating and maintaining social circles.

FIG. 4 depicts a screen-shot of an example web page including an activity stream for a user of a social networking service.

FIG. 5 depicts an example collection of items distributed by users of a social networking service.

FIG. 6 depicts a screen-shot of an example search stream for a user of a social networking service.

FIGS. 7A and 7B depict item sharing to the example search stream of FIG. 6.

FIG. 8 depicts an example search stream sharing interface.

FIG. 9 is a flowchart of an example process that can be executed in implementations of the present disclosure.

Like reference numbers represent corresponding parts throughout.

### DETAILED DESCRIPTION

In general, implementations of the present disclosure are directed to displaying items in stream pages of users of a social networking service. In particular, implementations of the present disclosure are directed to generating search results based on a search query provided to a search engine of a social networking service. In some examples, the search results include items distributed by one or more users of the social networking service and are displayed in a search stream. In some examples, the items are access controlled such that only items that are accessible by a searching user (e.g., the user that submitted the search query) are provided in the search stream. In some implementations, a user viewing a search stream can distribute items directly to the search stream. In some examples, source indication data can be appended to an item data set associated with an item shared directly to the stream. The source identification data can indicate that the item was shared directly to the stream. In this manner, the item will be captured and will be part of the search stream in a subsequent recreation of the search stream. Further, and in some implementations, a filter can be applied to the search stream to only display items that were shared directly to the search stream. In some examples, the source indication data can be used to distinguish between items shared directly with the search stream and items shared with other search streams and/or shared generally through the social networking service. In some implementations, and in response to a user sharing an item directly to the search stream, a notification is generated to identify the user to other users viewing the search stream. In some implementations, users can share the search stream with other users. In some examples, a user can distribute an item to other users of the social networking service, the item including a graphical representation of the search stream and enabling the other users to access the search stream. In some implementations, and in response to a user sharing the search stream, a notification is generated to identify the user to other users viewing the search stream.

For purposes of illustration, implementations of the present disclosure are described within the context of an example social networking service. The example social networking service enables users to organize contacts into social circles. It is appreciated, however, that implementations of the present disclosure can be used in other types of social networking services and are not limited to social networking services that include social circles.

In general, social circles are categories to which a user can assign contacts and better control the distribution and visibility of social networking items distributed using the social networking service. In some implementations, a social circle can be provided as a data set defining a collection of contacts that are associated with one another in a computer-implemented social networking service. Generally, a social circle can be described from the perspective of an individual that is the center of a particular collection of socially interconnected people, or from the aggregate perspective of a collection of socially interconnected people. A social circle can have narrowly defined boundaries (e.g., members of the social circle might be familiar with one another) and permission may be required for a member to join a social circle. A user of the social networking service can define a social circle. The social circle, as a data set defining a collection of contacts, may reflect real-life social connections and/or interactions of the user. In some implementations, a social circle can be defined by a user as a personal representation or grouping of a set of contacts, the contacts may be unaware of the social circle and/or unaware of other members of the social circle.

Through the creation and use of social circles, the user can organize and categorize social networking contacts into various different groupings that can be used to control the visibility and access those contacts have to the items of digital content, such as text, digital images, videos, audio files, hyperlinks (e.g., uniform resource indicators, URIs), and/or other appropriate digital content distributed by the user or associated with the user's social networking profile. As one example, the user can distribute an item including an update about a work-related nuance to only a “coworker” circle, and spare other contacts within the social networking service from seeing information that is irrelevant to them.

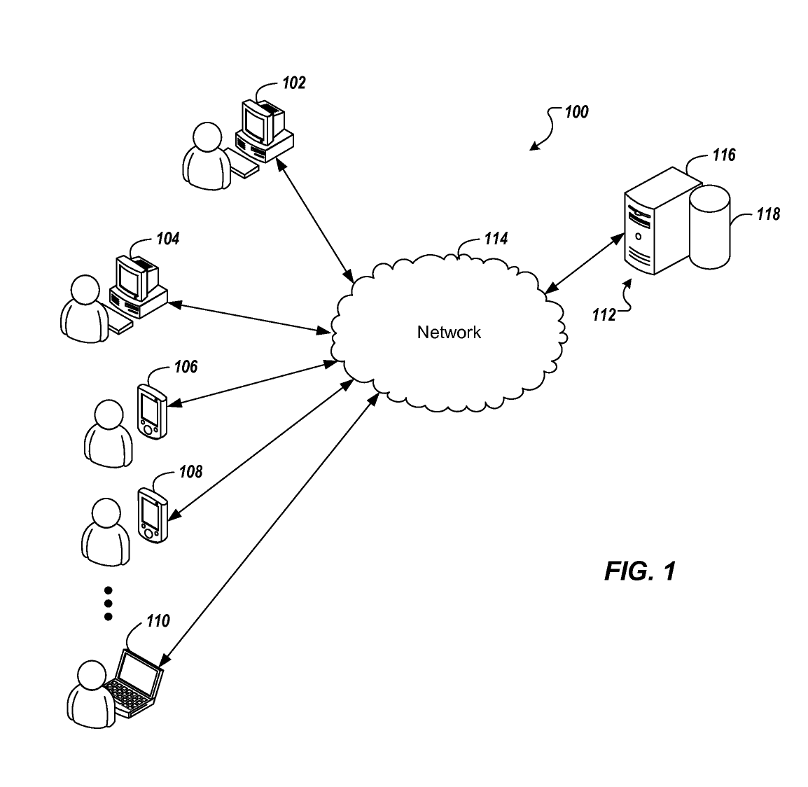

FIG. 1 is a diagram of an example network architecture 100. The network architecture 100 includes a number of client devices 102-110 communicably connected to a server system 112 by a network 114. The server system 112 includes a processing device 116 and a data store 118. The processing device 116 executes computer instructions stored in the data store 118, e.g., to perform the functions of a social network server.

Users of the client devices 102-110 access the server device 112 to participate in a social networking service. For example, the client devices 102-110 can execute web browser applications that can be used to access the social networking service. In another example, the client devices 102-110 can execute software applications that are specific to the social networking service (e.g., social networking “apps” running on smartphones).

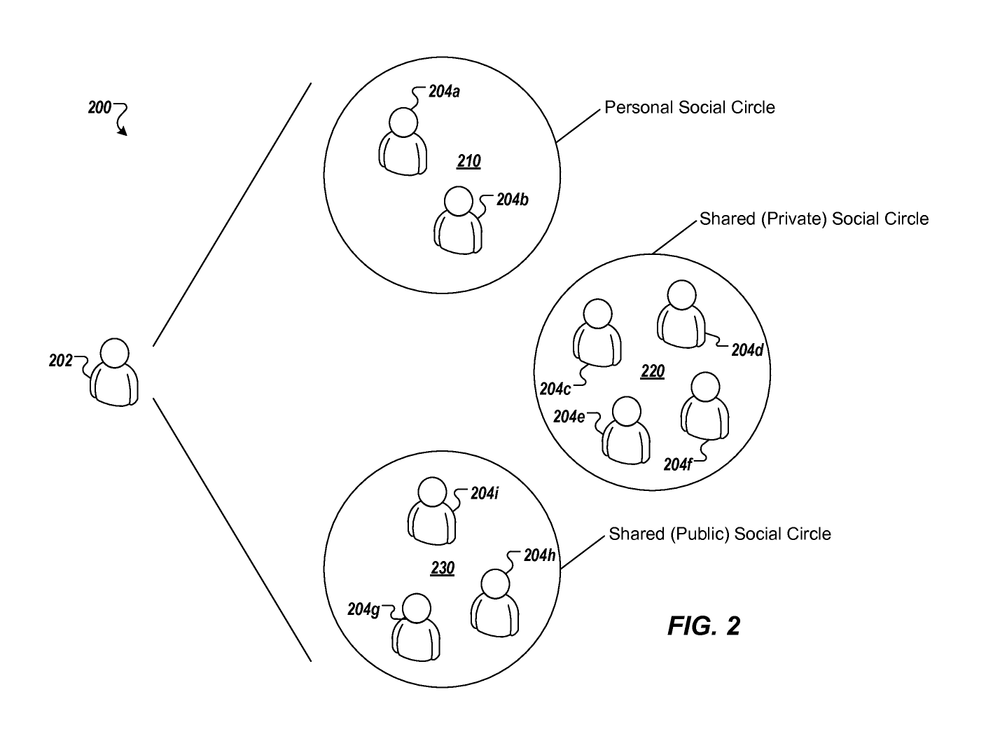

Users interacting with the client devices 102-110 can participate in the social networking service provided by the server system 112 by digital content, such as text comments (e.g., updates, announcements, replies), digital images, videos, audio files, and/or other appropriate digital content. In some implementations, information can be posted on a user's behalf by systems and/or services external to the social networking service or the server system 112. For example, the user distribute an item including a review of a movie to a movie review website, and with proper permissions that website can cross-post the review to the social networking service on the user's behalf. In another example, a software application executing on a mobile device, with proper permissions, can use global positioning system (GPS) capabilities to determine the user's location and automatically update the social network with his location (e.g., “At Home”, “At Work”, “In Brownsdale, Minn.”). Generally, users interacting with the client device 102-110 can also use the social networking service provided by the server system 112 to define social circles to organize and categorize the user's relationships to other users of the social networking service. Examples of the creation and use of social circles are provided in the description of FIG. 2.

In some implementations, the client devices 102-110 can be provided as computing devices such as laptop or desktop computers, smartphones, personal digital assistants, portable media players, tablet computers, or other appropriate computing devices that can be used to communicate with an electronic social network. In some implementations, the server system 112 can be a single computing device such as a computer server. In some implementations, the server system 112 can represent more than one computing device working together to perform the actions of a server computer (e.g., cloud computing). In some implementations, the network 114 can be a public communication network (e.g., the Internet, cellular data network, dialup modems over a telephone network) or a private communications network (e.g., private LAN, leased lines).

FIG. 2 is a diagram of an example social network 200 including social circles. A user 202 is a member of a social network that supports the creation and use of social circles (e.g., the social network provided by the server device 112 of FIG. 1). In the present example, the user 202 has a number of contacts 204a-204i with which the user 202 can have some form of relationship (e.g., friends, coworkers, customers, teammates, clients, relatives, club members, classmates). The user 202 categorizes the contacts 204a-204i by assigning them to one or more social circles, such as a social circle 210, a social circle 220, and a social circle 230. A social circle 240, which has a number of contacts 242a-242c, is provided as a query-based social circle that can be automatically generated without input from the user 202. In some implementations, the social circle 240 can be generated based on information gathered from and has some commonality among the user 202 and the users 242a-242c (e.g., posts, uploaded photos, check-ins, volunteered location information).

The social circle 210 is a personal circle. In some implementations, personal circles are groupings created by and might be known only to the user 202 (e.g., the contacts 204a, 204b may receive no indication that they are in the user's 202 personal social circle 210). In some implementations, personal social circles are groupings created by the user 202 and may be known to the user 202 as well as the contacts (e.g., contacts 204a, 204b) that are members of the social circle (e.g., the contacts 204a, 204b receive an indication that they have been added to the personal social circle 210).

In some implementations, personal circles can be used to organize and categorize the contacts 204a-204i in ways that are relevant to the user 202. In some implementations, the user 202 may use personal social circles to organize contacts in order to discretely target which of his contacts 204a-204i will see certain items or have access to particular information. For example, the user 202 may be planning a surprise party for a small group of friends. As such, the user can organize contacts into “Surprise Party Attendees” and “Surprise Party Honorees” personal circles. By doing so, the user 202 may better target selected items to the friends attending and/or helping to plan the surprise party (i.e., Surprise Party Attendees), while targeting selected items to friends that are to be honored at the surprise party (i.e., Surprise Party Honorees) to maintain the integrity of the surprise.

The social circle 220 is a shared private circle, which may also be referred to simply as a shared circle. In general, shared private circles are social circles that the user 202 creates and invites contacts to voluntarily join. Contacts that accept the invitation become members of the shared private circle. Members of a shared private circle can see information posted to that circle by the user 202 and can distribute information to be shared with other members of the shared private circle. For example, the user 202 may tend to distribute a large number of jokes to the social network. However, while some of the contacts 204a-204i may find the jokes to be entertaining, others may find them to be simply annoying. Realizing this, the user 202 may create a “jokes” shared private circle and invite some or all of the contacts 204a-204i to join. With the “jokes” social circle in place, the user 202 may distribute witticisms to the “jokes” circle, and only those contacts who have accepted the invitation are able to see the comicality of the user 202. Similarly, members of the shared private circle are able to distribute messages to the circle, and those messages are visible to other members of that circle.

The social circle 230 is a shared public circle. In general, shared public circles are social circles that the user 202 creates, and invites contacts to voluntarily join. Further, the existence of a shared public circle is publicly available such that other users of the social networking service (e.g., not necessarily just the user's 202 contacts 204a-204i) may request to join the public social circle. Members of shared public circles may distribute information to, and see updates distributed by, other members of the same public shared circle. In some implementations, public shared circles may be “fan” or “group” circles (e.g., circles dedicated to a particular place, event, product, movie, celebrity, sports team, company, concept, philosophy, organization, support network). For example, the user 202 may create a shared public circle for his band, and fans of his act can join the circle to discuss upcoming shows, download MP3s of the band's music, or post videos from recent concerts. In another example, the user 202 can create a shared public circle for alumni of his high school graduating class, which his former classmates may find and join in order to stay in touch with one another and distribute pictures from their school days. Once a shared public circle is created, in some implementations, the user 202 can invite people to join the circle. In some implementations, nonmembers of the circle can request membership in the shared public circle, and membership in a shared public circle may be automatic upon request, or may require the user's 202 approval to become members of the shared public circle.

In some implementations, one or more default social circles can be provided or suggested to a user when the user subscribes to a social networking service. For example, “Friends,” “Family,” and “Coworkers” social circles can automatically be provided in a user's profile upon the user subscribing to the particular social networking service. Other social circles can automatically be provided including, for example, an “Acquaintances” social circle and/or a “Just Following” social circle. In some implementations, the automatically created or suggested social circles can include personal social circles. Although default social circles can be automatically provided, it can be left to the user to actually populate the default social circles with contacts. For example, each of the default social circles can initially be empty of contacts, and the user populates each of the default social circles as discussed in further detail herein.

In some examples, digital content can be distributed using the social networking service, such that it is publicly available to all users of the Internet. In some examples, digital content can be distributed to all users of the social networking service, such that it is accessible by any user of the social networking service. In some examples, digital content can be distributed to contacts within the social networking service including one or more social circles, such that they are exclusively viewable by the indicated contacts and/or contacts within one or more indicated social circles. For example, a user of the social networking service can generate an item including digital content and indicate one or more social circles for distribution of the item. In some implementations, an auto-complete component enables the user to type in part of the name of a social circle and/or individual contact to specify which social circles and/or individual contacts require delivery of the item content. During an item write-time, an item data set is transmitted from the user's client computing device (e.g., client device 102 of FIG. 1) to a distribution hub, which can be provided at a server (e.g., server system 112 of FIG. 1). In some implementations, the item data set includes item content data (e.g., text, uniform resource indicator (URI)), timestamp data (e.g., a timestamp indicating the time that the post was generated), distribution data (e.g., contacts and/or one or more social circles), and identification (ID) data (e.g., an ID assigned to the item data set upon generation of the item).

In some implementations, and as discussed in further detail herein, other data can be appended to item data sets. Example other data can be spam indication data and scoring data. In some examples, spam indication data can be appended to an item data set to indicate that the item data set is considered to be spam. In some examples, scoring data can include a social affinity score among other possible scoring data. In some examples, source indication data can be appended to the item data set to indicate the route through which the user distributed the item, as discussed in further detail herein. In some implementations, with the permission of a user, location data can be appended to item data sets. The location data can indicate the location from which an associated item was distributed. In some examples, the location data can be determined based on an explicit indication of location by the user (e.g., a check-in), wifi signal locating, GPS signal locating, cellular tower triangulation, IP address and/or any other appropriate technique for determining the location from which a user distributes an item to the social networking service.

In some implementations, the distribution data is processed to provide an access control list (ACL) that specifies which users are granted access to the item content. In some examples, the users include users of the social networking service. In some examples, the users include users of the Internet.

Generally, the distribution hub determines end points the item data set is to be distributed to based on the ACL. More specifically, the set of contacts that may care about the item and/or that are allowed access to the item is determined based on the ACL, and the ID of the item is written to a per user/view index at the distribution hub. When fetching items to distribute to a user, the user/view index is accessed and the IDs of the various items that the user is allowed to view are determined. The item data sets are retrieved from a data store (e.g., data store 118 of FIG. 1) and are transmitted to a client device associated with the requesting user. In some implementations, and as discussed in further detail herein, the ACL can be provided based on the overall score, the quality score and/or the social affinity score.

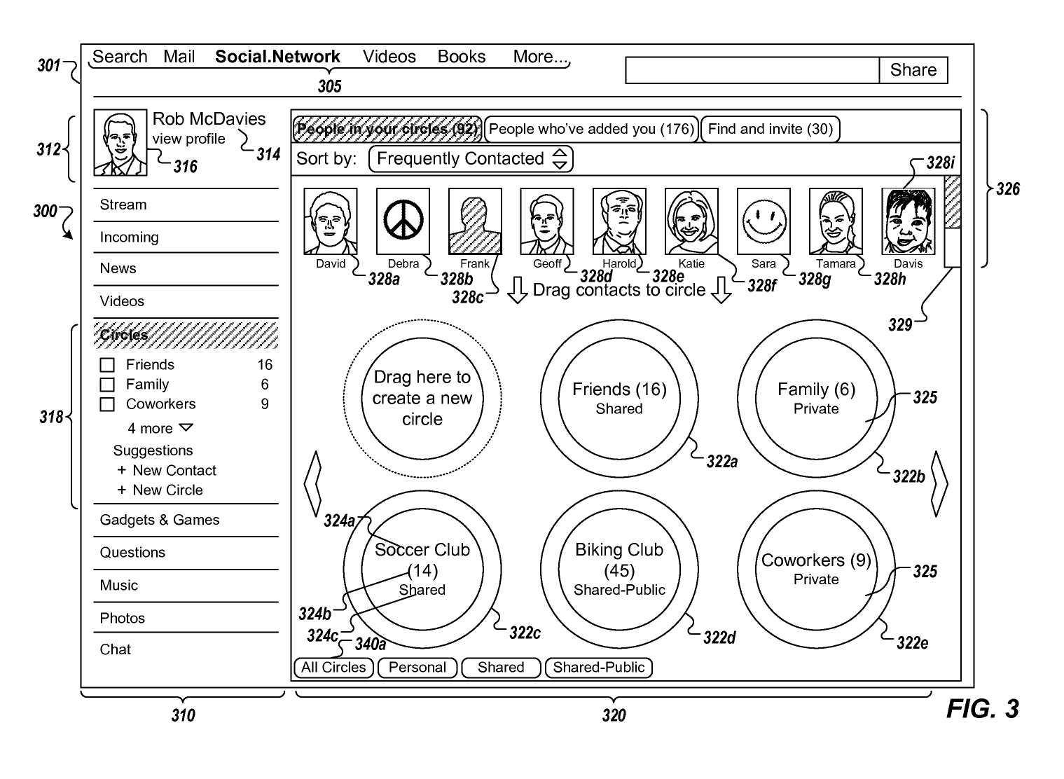

FIG. 3 depicts a screen-shot 300 of an example graphical user interface for creating and maintaining social circles. In the screen-shot 300, a social graph editor user interface (UI) 301 is shown. In some implementations, the UI 301 can be the interface presented by a purpose made social networking application, while in some implementations the UI 301 can be one or more web pages of a social networking website displayed in a general purpose web browser.

In the example of FIG. 3, the UI 301 includes a number of choices presented in a menu bar 305. In the present example, the “Social Network” choice has been selected by a user. This selection causes a web-based social networking application to be executed and a social network menu 310 to be displayed. The social network menu 310 includes a profile indicator 312 in which information such as a user name 314 and a user image 316 associated with the currently logged in user are displayed.

The social network menu 310 also displays, among other items, a social circles sub-menu 318. The social circles sub-menu 318, when selected (e.g., as represented by the highlighting of the submenu's title), causes a social circle display 320 to be presented. The social circle display 320 includes a number of circles 322a-322e that are visual representations of various social circles that the user has created or has permission to edit. Each of the circles 322a-322e displays information about the social circle it represents. For example, the circle 322c displays a name 324a, a count 324b of the number of contacts associated with the social circle, and an indication 324c of what kind of circle (e.g., personal, private shared, public shared) that the circle 322c is.

The social circle display 320 also includes a contact display 326. The contact display 326 provides a graphical interface for viewing, selecting, and organizing items in the user's contact lists. A collection of contact icons 328a-328i represents the contacts or other entities (e.g., organizations, places, or other items) socially networked with the particular user. In some implementations, the icons can be digital photos of the contacts they represent (e.g., the icons 328a, 328d), arbitrary images (e.g., the icons 328b, 328g), or placeholders (e.g., when the contact has no image associated with their account, such as the icon 328c). In some implementations, the icons can include additional information, such as the names of each contact. A scroll bar 329 is provided for the user to view additional contact icons that may not fit into the initial view.

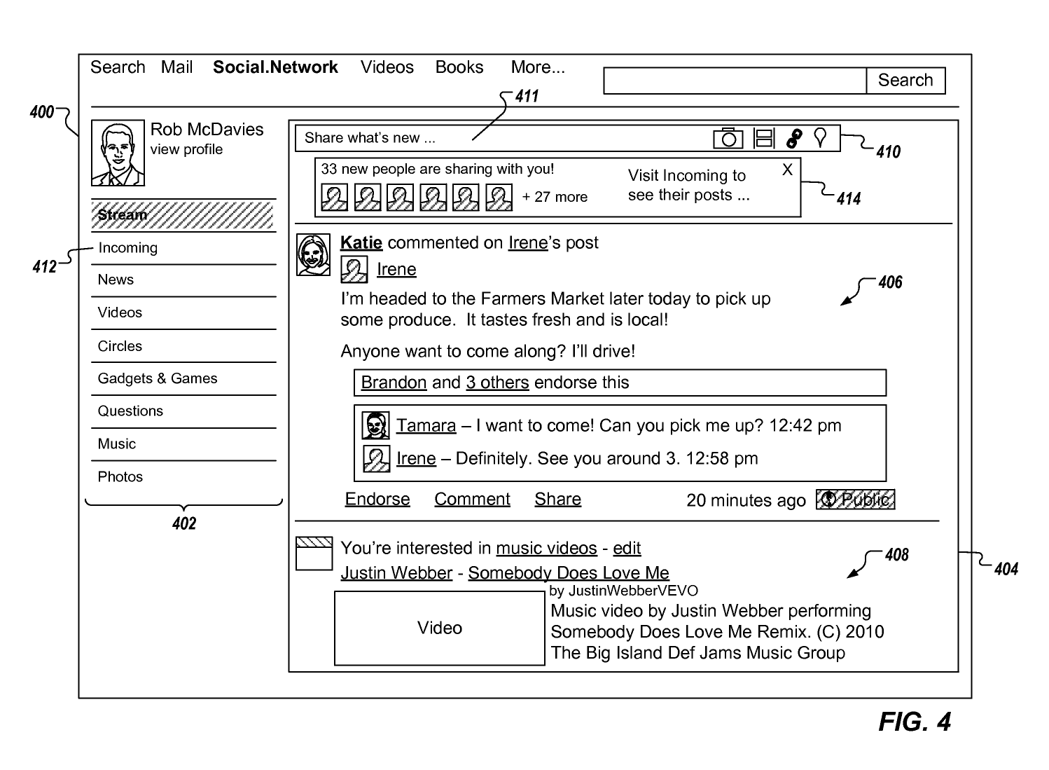

FIG. 4 depicts a screen-shot of an example web page 400 including an activity stream 404 for a user of a social networking service. For example, the web page 400 can be provided as a web page within a website of a social networking service, and can display items of digital content that have been shared with a user associated with the web page 400. In the illustrated example, the example user includes “Rob McDavies” and the web page 400 displays items of digital content that other users have shared with the user and/or items that the user has shared with other users. The web page 400 includes a social network menu 402 and the activity stream 404. As used herein, the term activity stream can include a graphically displayable collection of items that have been distributed to and/or from, or are otherwise accessible by a user of a social networking service. Example items 406, 408 that have been distributed to the user are displayed in the activity stream 404. Generally, the items 406, 408 displayed in the activity stream 404 include digital content that is distributed to the user from contacts established within the social networking service. A content sharing interface 410 can also be provided. The user can activate (e.g., click on) the content sharing interface 410 to share digital content. Although two items 406, 408 are depicted in FIG. 4, it is appreciated that the activity stream 400 can display any number of items to the user.

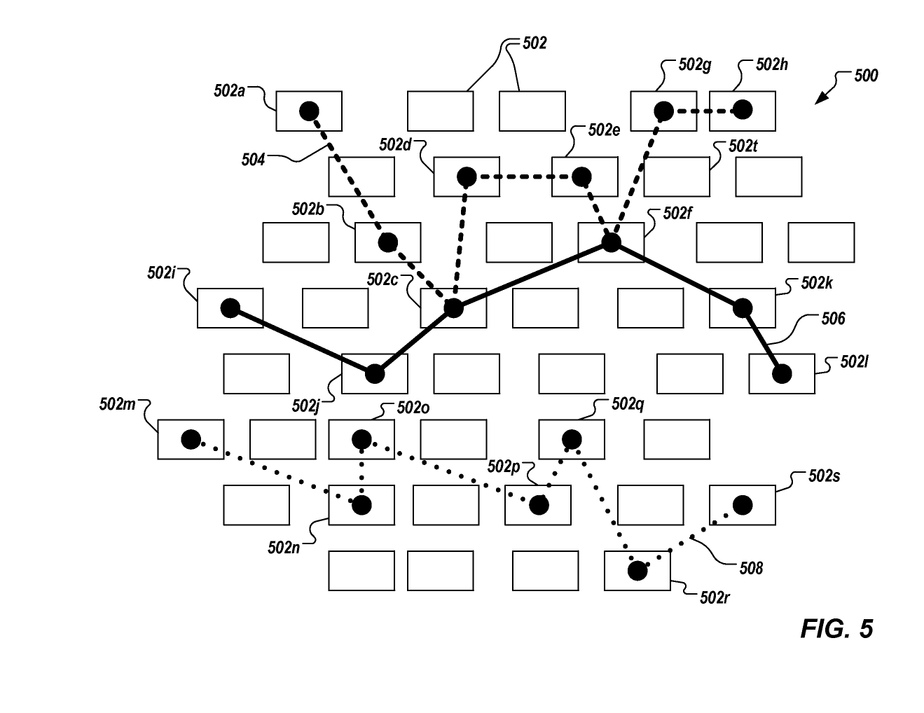

FIG. 5 depicts an example collection 500 of items 502 distributed by users of a social networking service. It is appreciated that more of fewer items 502 can be provided in the corpus 500 and the number of items 502 depicted in FIG. 5 is a non-limiting example number of items 502. The number of items 502 of the collection 500 can vary. In some examples, if a user that distributes an item 502 subsequently deletes the item 502, the item 502 can be deleted from the collection 500. In some examples, as more items are generated and are distributed through the social networking service, the number of items 502 can increase.

In some implementations, each of the items 502 can be identified in one or more search indices based on keyword. For example, an item 502 can be processed (e.g., using a server system) to extract one or more keywords that can be associated with the item 502. A search index can be provided that associates the item 502 to the one or more keywords. For example, an item identifier associated with the item 502 can be indexed to the one or more keywords. In this manner, the search index can be used to identify one or more items 502 in response to a search query that can include at least some of the one or more keywords.

Implementations of the present disclosure are directed to identifying and displaying search results in a search stream within a social networking service in response to a request for content. The request can include one or more search terms. The search results can include items distributed by users of the social networking service and the search stream can be provided in a format that resembles an activity stream or newsfeed associated with the social networking service. In some examples, one or more resources associated with the search results can be fully accessed from the search stream (e.g., without navigating away from the presented search results). In this way, search results can be presented in a format that is familiar to a user and can also include fully functional resources that can be accessed by the user without navigating away from the presented search results.

In some implementations, the search stream is provided as a dynamic search stream such that the search results are automatically updated without requiring user input. In some examples, as new items are distributed through the social networking service, the new items can be cross-referenced with the search query that resulted in the search stream. If a new item is determined to be relevant to the search stream and the user that submitted the search query is authorized to view the new item, the search stream is refreshed to include the new item. In some examples, the search stream is refreshed in real-time. In some examples, the terms real-time can indicate that a new item is received and processed by a backend system (e.g., a server system) without intentional delay, taking into account the processing limitations of the backend system and the time required to accurately process the item.

The search results presented in the search stream can include user data that is specifically authorized by one or more users for such use. For example, one or more users (e.g., users that are associated with posts to the social networking service) can authorize their respective user data to be used and presented as or with search results in a search stream.

Implementations of the present disclosure are further directed to distributing items directly to a search stream. In some implementations, a search stream is generated and is displayed in response to a request including one or more search terms provided from a searching user. The searching user can generate an item that can be shared directly to the search stream. In this manner, a subsequent generation of the search stream (e.g., by the sharing user and/or other users of the social networking service) will include the item distributed by the sharing user. In some examples, source indication data can be appended to an item data set associated with an item shared directly to the stream. The source identification data can indicate that the item was shared directly to the stream. In this manner, the item will be captured and will be part of the search stream in a subsequent recreation of the search stream.

Implementations of the present disclosure are also directed to filtering items displayed in a search stream within a social networking service. In some examples, items can be filtered to include items that were shared directly to the search stream. For example, a filter can be applied to the search stream to only display items that were shared directly to the search stream. In some examples, the source indication data can be used to distinguish between items shared directly with the search stream and items shared with other search streams and/or shared generally through the social networking service. In some implementations, and in response to a user sharing an item directly to the search stream, a notification is generated to identify the user to other users viewing the search stream. In some implementations, users can share the search stream with other users. In some examples, a user can distribute an item to other users of the social networking service, the item including a graphical representation of the search stream and enabling the other users to access the search stream. In some implementations, and in response to a user sharing the search stream, a notification is generated to identify the user to other users viewing the search stream.

Referring again to FIG. 5, the collection 500 includes items 502. Items 502 can be identified based on one or more search terms provided in a request or query and can be displayed in a search stream. In the example of FIG. 5, search streams 504, 506, 508 are schematically depicted. As used herein, the term search stream can include a graphically displayable collection of items that are identified based on a search query. It is appreciated that the search streams 504, 506, 508 are example search streams and that search streams can include various numbers of items. The search streams 504, 506, 508 can each be generated in response to a search query. For example, one or more first queries can be received and can be processed to generate the search stream 504, one or more second queries can be received and can be processed to generate the search stream 506, and one or more third queries can be received and can be processed to generate the search stream 508.

The search stream 504 includes items 502a-502h. In some examples, the items 502a-502h can be associated with one or more keywords through a search index and can be identified as search results in view of a search query using the search index. The search stream 504 represents the collection of items 502a-502h as search results and can be displayed as a search stream to a searching user, as discussed in further detail below. The search stream 506 includes items 502i-502l, 502c and 502f. In some examples, the items 502i-502l, 502c and 502f can be associated with one or more keywords through the search index and can be identified as search results in view of a search query using the search index. The search stream 506 represents the collection of items 502i-502l, 502c and 502f as search results and can be displayed as a search stream to a searching user. The search stream 508 includes items 502m-502s. In some examples, the items 502m-502s can be associated with one or more keywords through the search index and can be identified as search results in view of a search query using the search index. The search stream 508 represents the collection of items 502m-502s as search results and can be displayed as a search stream to a searching user.

In some implementations, the items 502 that are to be displayed to a searching user within a search stream 504, 506, 508 can be determined based on the search query and the searching user. For example, and as discussed herein, a user that generates an item (an author user) can define a distribution for the item. In some examples, the distribution can be public, such that any user can access the item. In some examples, the distribution can be limited such that only users specified in the distribution are able to access the item.

With continued reference to FIG. 5, and by way of non-limiting example, a searching user can provide a search query. In response to the search query, items 502a-502h and 502t can be identified as search results in view of the search query. Each of the items 502a-502h and 502t can include an associated distribution defined using an ACL. It can be determined that the distributions associated with the items 502a-502h include the searching user. For example, one or more distributions associated with the items can include public distributions, such that every user is able to access the respective item. As another example, one or more distributions associated with the items can identify the searching user, such that the search user is able to access the respective items. It can be determined that the item 502t does not include the searching user. For example, the distribution associated with the item 502t can be a limited distribution that is targeted to an audience that does not include the searching user. Consequently, although the item 502t is relevant to the search query submitted by the searching user, the searching user is not authorized to access the item 502t. In view of this, the search stream 504 can be generated and can include the items 502a-502h to be displayed to the searching user.

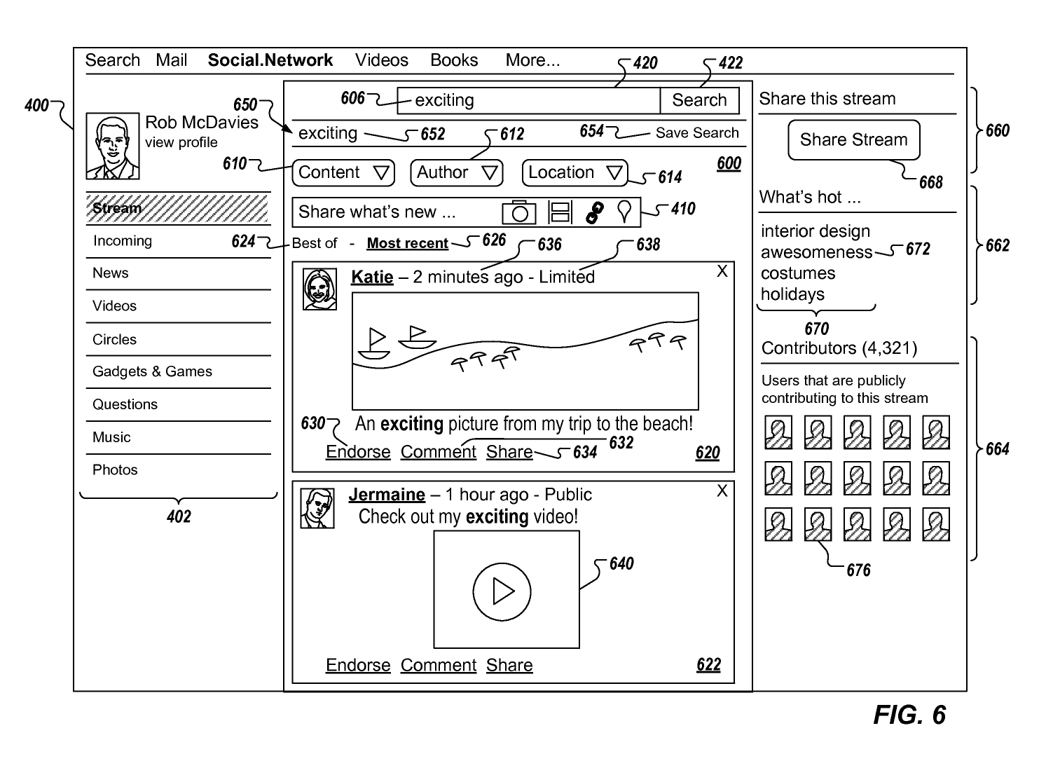

FIG. 6 depicts a screen-shot of an example search stream 600 for a user of a social networking service. In the example of FIG. 6, the search stream 600 is displayed within the web page 400. In this example, the web page 400 includes the search field 420 in which a search query 606 (e.g., a text or image query) can be entered. In this example, the search query 606 is the term “exciting.” When the search term 606 is submitted as a search query to the social networking service (e.g., upon activation of the search control 422), the social networking service returns the search stream 600 including items that relate to the search term 606.

In some examples, the type of content displayed in the search stream 600 can be defined before or after the search is executed. For example, filter controls 610, 612, 614 can be activated to limit the displayed items, as discussed in further detail below. In the depicted example, the search stream includes an item 620 and an item 622, as well as one or more other items that are not currently visible. The one or more other can be viewed, for example, by scrolling up or down the search stream 600 using a scroll control (not shown). The items of the search stream 600 can be sorted according to sort controls 624, 626. In the depicted example, the items of the search stream 600 are displayed in order of time posted. For example, the items are displayed in descending order based on the time at which the items were distributed to the social networking service.

As shown in FIG. 6, the search stream 600 can be presented in a format that resembles the format in which an activity stream is presented (e.g., the activity stream 404 of FIG. 4). For example, the search stream 600 can have the same look and feel as an activity stream associated with the social networking service. The search stream 600 can be organized and presented in a manner that resembles the postings and content that would appear in a user's activity stream. For example, the items 620, 622 are displayed in a format that is similar to the format in which the items 406, 408 are displayed in the activity stream 404. For example, borders and shapes of the items can be similar, and the placement of endorsement controls 630, comment controls 632, re-sharing controls 634, a timestamp 636, and the visibility indicator 638 can be similar to like controls and indicators of the activity stream 404.

The stream format can also specify how other features are presented. For example, the presence and/or placement of mute, block, comment, share, and content tag features can also be specified by the stream format and can be followed by the activity stream and the search stream. Further, the stream format can also specify a presence and/or placement of privacy controls (e.g., what members or groups may view certain content), a collapsible structure (e.g., content windows that can be collapsed or minimized in response to the activation of a control), or a tabbed structure (e.g., a structure that enables content to be opened in tabs within a single user interface, for example, a browser). Presenting activity and search streams in a common stream format enables the social networking service to provide content to users in a familiar format so that users may more easily find and interact with the content they are seeking.

In some examples, content associated with items 620, 622 within the search stream 600 can be accessed in its entirety without leaving the search stream 600 or the social networking service. For example, the item 622 includes video content 640 (e.g., a video clip) that can be accessed or played by activation of associated controls. Accordingly, the search stream 600 can provide digital content that is immediately accessible to users. For example, a user viewing the search stream 600 need not navigate away from the search stream 600 to access the video content 640. Other types of content can also be accessed (e.g., in its entirety) within the search stream 600. For example, articles, audio content (e.g., music files), image content (e.g., images, for example, pictures in native resolution) and other content can be fully accessed within the search stream 600.

With continued reference to FIG. 6, the search stream 600 includes a search summary 650. In the depicted example, the search summary 650 includes a recitation 652 of the search query used to generate the search stream 600 and provides a save control 654 to enable the searching user to save the search. For example, the searching user can activate (e.g., click on) the save control 654 to save the search. In this manner, instead of recreating the search stream 600 by submitting another search query 606, the searching user can select a saved search from a list of saved searches (not shown).

In some implementations, the web page 400 includes a stream sharing section 660, a popular search section 662 and/or a contributors section 664. The stream sharing section 660 includes a stream sharing control 668. The user can share the displayed search stream (e.g., the search stream 600) to other users of the social networking service by activating (e.g., clicking on) the stream sharing control 668, as discussed in further detail herein. The popular search section 662 includes a list 670 of popular search queries 672 that have been submitted by users of the social networking service to generate respective search streams. In some implementations, each search query 672 can be provided as a control such that, when a user activates (e.g., clicks on) a search query 672, a corresponding search stream is automatically displayed. In some examples, and in response to the user clicking a search query 672, the search query is submitted to and is processed by a search engine to identify one or more items that are relevant to the search query, the items are filtered to include only items that the user is able to access, and the items are displayed as a search stream. The contributors section 664 provides graphical representations 676 and/or other information associated with users that have contributed one or more items to the particular search stream being displayed. In the example of FIG. 6, the graphical representations 676 include thumbnail images associated with the respective users, each thumbnail image corresponding to an author user of an item that is displayed in the search stream 600. In some examples, the graphical representations 676 can be activated to provide further detail regarding a particular contributor. For example, a user can activate (e.g., click on) a graphical representation 676 and, in response, a profile page associated with the particular contributor can be displayed. In some examples, a user can hover over a graphical representation 676 and, in response, information regarding the particular contributor can be displayed.

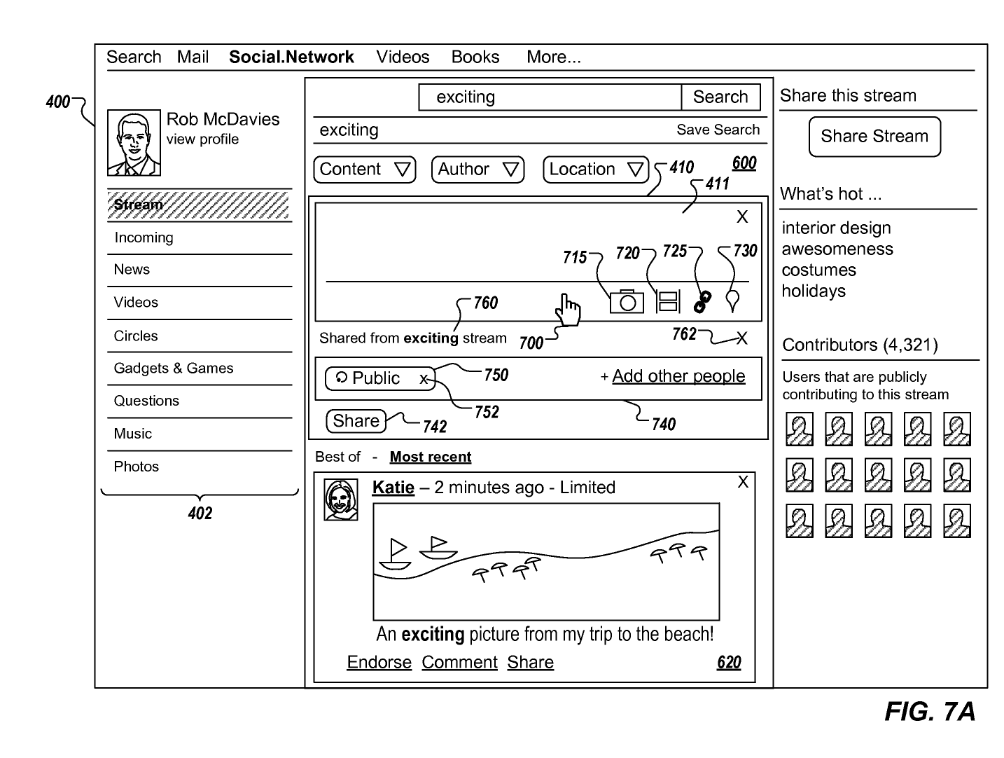

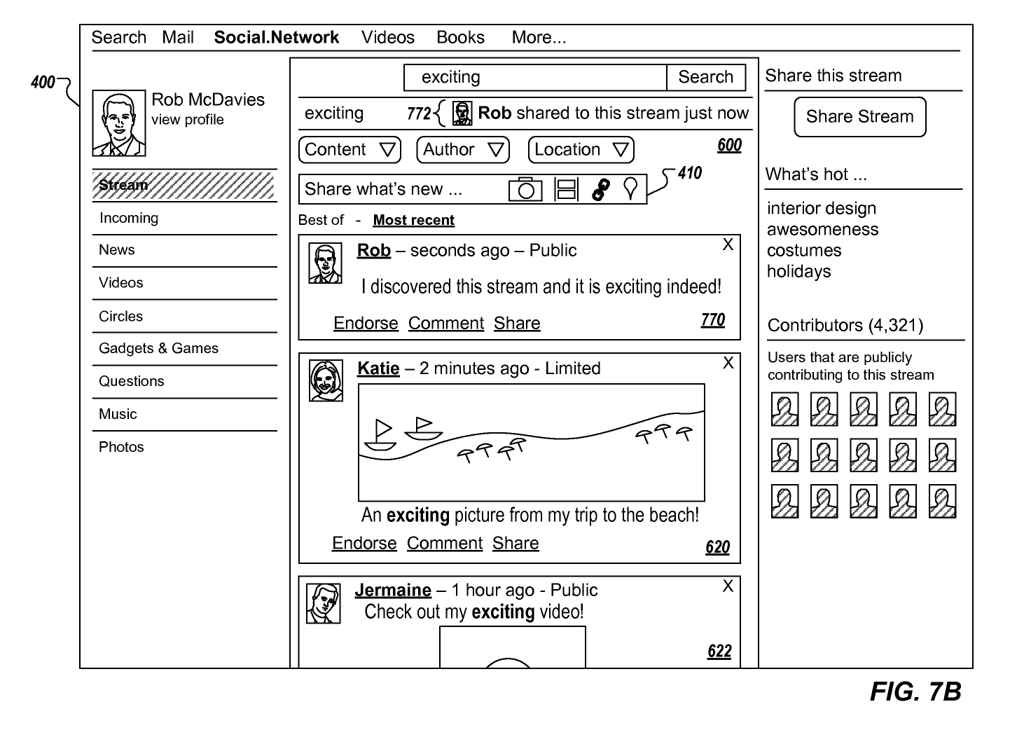

FIGS. 7A and 7B depict item sharing to the example search stream 600 of FIG. 6. As discussed in further detail below, a user can share items directly to the search stream 600 using the content sharing interface 410. For example, the user “Rob McDavies” can activate (e.g., click on) the content sharing interface 410 to initiate generation and distribution of an item to be included in the search stream 600.

The content sharing interface 410 includes the content entry area 411. In some implementations, the user can select the content input area 411 to input and/or select digital content for distribution. For example, a pointer 700 can be used to interact with (e.g., click on) the content input area 411 and initiate an interaction with the content sharing interface 410. For example, the user can click on the content entry area 411 to initiate the entry of text as part of an interaction with the content entry area 411.

In some implementations, the user can select an icon 715, 720, 725, 730 to initiate input and/or selection of digital content that is to be distributed. In the illustrated implementation, for example, the user can select an icon 715 to initiate a process for selecting a digital image (e.g., stored in computer-readable memory) to be distributed. For example, the user can click on the icon 715, and, in response to the click, a user interface can be presented in which the user may be able to upload a digital image file, select a digital image file that was previously uploaded, and/or provide a URL corresponding to a digital image found elsewhere on the Internet. In some implementations, once a digital image file has been identified, a thumbnail of the digital image and/or information about the image (e.g., address, filename, caption, title, size, date taken) may appear in the content input area 411.

In the illustrated implementation, for example, the user can select an icon 720 to select a digital video (e.g., stored in computer-readable memory) to be distributed. For example, the user can click on the icon 720, and, in response to the click, a user interface can be presented in which the user may be able to upload a digital video file, select a digital video file that was previously uploaded, and/or provide a URL corresponding to a digital video file found elsewhere on the Internet. In some implementations, once a digital video file has been identified, a thumbnail frame capture of the digital video and/or information about the digital video (e.g., address, filename, description, title, size, date taken) may appear in the content input area 411. In some implementations, shared content may be accompanied by information other than a URL or other identifier. For example, the user may click on the icon 720 to share an identified video as shared content. The shared content can include not only an identifier of the video content, but also a playback start point and duration. In such an example, the user can share a subsection of the identified video with his targeted contacts.

In the illustrated implementation, for example, the user can select an icon 725 to provide a hyperlink (e.g., to a URL) for distribution. For example, the user can click on the icon 725, and, in response, a user interface can be presented in which the user may be able to type or paste in a uniform resource locator (URL) of a web page that the user intends to share. In some implementations, once a URL has been identified, a thumbnail preview of the identified page and/or information about the page (e.g., URL, website, page title, a thumbnail of a photo selected from the identified page) can be displayed in the content input area 411.

In the illustrated implementation, for example, the user can select an icon 730 to select a map location for distribution. For example, the user can click on the icon 730, and, in response, a user interface can be presented in which the user may be able to identify a place (e.g., business, landmark, facility, city) and/or a geographic location (e.g., physical address, latitude and longitude) that the user intends to share. In some implementations, once a location has been identified, a thumbnail map of the identified location and/or information about the location (e.g., URL, physical address, place name, a thumbnail of a photo of the identified place) can be displayed in the content input area 411.

In some implementations, when the icon 730 is activated, a user interface can be presented to provide the user with a collection of suggested places. For example, by activating the icon 730, a process can be initiated in which the user's current location can be determined, and that location information can be used to search for and identify a list of nearby places that the user may wish to share. In some implementations, by activating the icon 730, a process can be initiated in which a content item or content provided by the user can be analyzed to identify one or more places that may be associated with the content. For example, the user may enter text including “Honeymoon at Mt. Rushmore” and then click on the icon 730. In response, a process may be initiated to analyze the entered text and suggest “Mt. Rushmore National Monument” and/or “Rushmore Honeymoon Cabins” as suggested locations that can be included as part of the digital content that is to be distributed.

With particular reference to FIG. 7B, the content sharing interface 410 can expand to include a distribution interface 740 and a share button 742. In some implementations, the distribution interface 740 and the share button can be displayed in response to user activity (e.g., clicking on) with the content input area 411 including activity with one or more of the icons 715-730. In some implementations, the content input area 411 also expands to provide additional room for input of digital content. The distribution interface 740 and the share button 742. The user can type or otherwise select identifiers to input into the distribution interface 740. The identifiers identify other users, categories of users and/or social circles to define distribution of the digital content (e.g., through a social network service). In some implementations, the identifiers can include contact identifiers, social circle identifiers, electronic messaging addresses, or any other appropriate identifier than can be used to identify one or more persons with whom content can be shared. The identifiers provided in the distribution interface 740 are used to generate an ACL that defines distribution of the digital content provided in the content input area 411.

An example identifier icon 750 is provided in the distribution interface 740. The identifier icon 750 is a visual representation of one or more users that the item is to be shared with. In the example of FIG. 7B, a user has tentatively indicated that item is to be shared publicly. In some examples, sharing the item publicly enables all users of the social networking service to access the item. In some examples, sharing the item publicly enables all users of the Internet to access the item. Until the item is committed, identifier icons provide a tentative distribution for the item. For example, the user can activate (e.g., click on) a delete control 752 to remove the identifier icon 750.

Once the user has defined and is satisfied with the distribution, the user can commit the item to be distributed. In some implementations, the user can activate (e.g., click on) the share button 742 to commit the item. Committing the item can cause operations to be performed to generate a corresponding item data set and distribute the digital content to the identified users, as discussed above.

In accordance with implementations of the present disclosure, the item can be shared directly to the displayed search stream 600. In some implementations, a source indicator 760 can be provided to indicate that the item being generated by the user will be an item that is shared directly to the particular search stream 600. Until the item is committed, the user can activate (e.g., click on) a delete control 762 to remove the source indicator 760. In this manner, the user can determine whether the item is to be shared directly to the particular search stream 600, or in general to the social networking service. For example, by sharing the item directly to the particular search stream, the user can ensure that the item is tied to the search stream such that it will be displayed within the search stream. In some examples, by sharing the item directly to the particular search stream, the item is appropriately indexed within a search index to be associated with search terms that would generate the search stream. In this manner, if the user and/or another user later recreate the search stream, the item will be included as an item displayed within the search stream. For example, and continuing with the example search query “exciting,” the item can be tied to the “exciting” search stream even though the digital content provided in the item would not otherwise be determined to be relevant to search terms that would identify the item as a search result (e.g., the item does not include the term “exciting”).

By sharing the item in general to the social networking service, the item is not necessarily tied to or relevant to a particular search stream. In some examples, the item might not be indexed within a search index, or might be indexed within a search index that is not associated with the particular search stream. For example, and continuing with the example search query “exciting,” the item would not be sure to be tied to the “exciting” search stream. The item could relate to the “exciting” search stream, however, if the item includes digital content that is relevant to search terms resulting in the “exciting” search stream (e.g., the item includes the term “exciting”).

Once the user commits the item for distribution, the corresponding item data set is generated and can include data, as discussed above. If the user shared the item directly to the displayed search stream, the item data set can also include source indication data directly tying the item to the particular search stream that the user shared the item to. In this manner, when the user and/or other users of the social networking service recreate the particular search stream, the item is displayed within the search stream. In some implementations, the item is automatically indexed to be tied to the search stream within a corresponding search index in response to the item having been shared directly to the search stream. In some examples, and as discussed in further detail below, the source indication data can be referenced to filter items displayed within a search stream.

Referring now to FIG. 7B, and in response to the user committing an item, the item can be immediately displayed in the search stream. For example, the user “Rob McDavies” can share an item directly to the search stream 600 such that, after committing the item, the item is displayed as item 770. In some examples, the search stream 600 is refreshed such that the item 770 is displayed in real-time in the search stream 600. In some examples, the terms real-time can indicate that the item is received and processed by a backend system (e.g., a server system) without intentional delay, taking into account the processing limitations of the backend system and the time required to accurately process the item. In some examples, refresh of the search stream 600 occurs in response to items being distributed that are relevant to the search stream 600, without requiring explicit user action (e.g., the user is not required to activate a refresh control).

In some implementations, a notification 772 can be generated when a user shares an item directly to the search stream 600. In the depicted example, and as discussed above, the user “Rob McDavies” shared the item 770 directly to the search stream 600. Consequently, the notification 772 indicates that that particular user shared an item to the particular search stream. In some examples, the notification 772 includes a thumbnail image associated with the sharing user and/or other identifying information (e.g., a user name), as well as a message indicating that the sharing user shared an item to the particular search stream. In some examples, a link can be provided to enable a user to click on the notification to access further information regarding the sharing user. For example, the thumbnail image and/or the user name can be associated with a hyperlink to a profile page of the sharing user within the social networking service.

In the example of FIG. 7B, the notification 772 is associated with the user “Rob McDavies,” who both shared the item 770 directly to the search stream 600 and is viewing the search stream 600. In some implementations, the notification 772 can be generated when any user shares an item directly to the search stream. For example, if the user “Katie” had shared the item 620 directly to the search stream 600, the notification 772 would have notified the user “Rob McDavies” that the user “Katie” had shared an item directly to the stream. In this manner, users viewing a search stream can be immediately notified when another user has shared an item directly to the search stream. Further, such notifications can encourage users to share items directly to the search stream, thereby contributing to the collection of digital content available through the social networking service.

Referring again to FIG. 6, items displayed within the search stream 600 can be filtered by applying one or more filters. As noted above, the search stream 600 includes filter controls 610, 612, 614. In some examples, the filter control 610 is a content filter control, the filter control 612 is an author filter control and the filter control 614 is a location filter control. In some examples, user activation of the filter controls 610, 612, 614 (e.g., user click) results in a drop-down menu being displayed. The drop-down menu can provide one or more filter options that are relevant to the particular context. For example, and in response to user activation of the content filter control 610, a drop-down menu can be displayed and can include filter options relating to content type can be displayed. Example filter options can include items distributed (e.g., textual posts), items representing video chats facilitated through the social networking service, images, videos, check-ins and the like.

In some implementations, filter options provided with the content filter control 610 can further include items that were directly shared to the search stream 600. In some examples, when the user selects a directly shared filter option, the search stream 600 is filtered to only display items that were shared directly to the search stream 600 by users. For example, and as discussed in detail above, the item 770 of FIG. 7B includes an item that was directly shared to the search stream 600. Consequently, selection of the directly shared filter option would result in the item 770 and any other items shared directly to the search stream 600 being displayed within the search stream 600. In this manner, the user can readily discern the amount of items actively shared to the search stream 600 versus items passively included in the search stream (i.e., items determined to be relevant to a search query that generated the search stream 600).

In response to user activation of the author filter control 612, a drop-down menu can be displayed and can include filter options relating to author users that generated and distributed the items displayed in the search filter 600. Example filter options can include a user contacts filter option and a user filter option. In some examples, the user contacts filter option filters the search stream 600 such that only items distributed by contacts of the user (i.e., the user applying the filter) are displayed within the search stream 600. In this manner, the user can readily discern which and how many of their contacts within the social networking service are distributing items that are relevant to the search stream 600. In some examples, the user filter option filters the search stream 600 such that only items distributed by the user (i.e., the user applying the filter) are displayed within the search stream 600. In this manner, the user can readily discern which items that they had previously distributed were determined to be relevant to the search query that generated the search stream 600.

In response to user activation of the location filter control 614, a drop-down menu can be displayed and can include filter options relating to locations from which items displayed in the search stream 600 were generated and distributed. Example filter options can include an everywhere filter option and one or more specific location filter options. For example, the everywhere filter option filters the search stream 600 such that items from any location are displayed in the search stream 600. As another example, a specific location filter option (e.g., Mountain View, Calif.) filters the search stream 600 such that items from the specific location are displayed in the search stream 600. In some examples, a location search option can be provided in the drop-down menu. The location search option can include a search interface into which the user can type the name of a location. The location provided by the user can be processed and one or more location results can be displayed to the user. The user can select a particular location from the one or more location results, and the items displayed in the search stream 600 can be filtered to only include items from the particular location.

Referring again to FIG. 6, the user can share the search stream 600 with other users. In some implementations, the user can activate (e.g., click on) the stream sharing control 668 to initiate sharing of the search stream 600. In some implementations, user activation of the stream sharing control 668 results in the display of a stream sharing interface, discussed in further detail below.

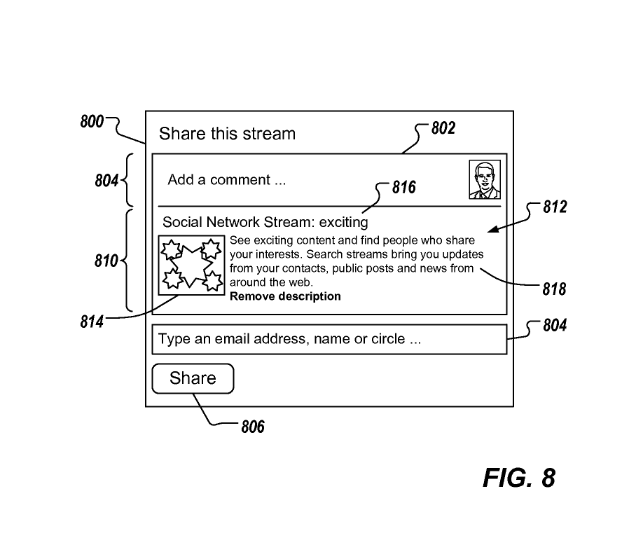

FIG. 8 depicts an example search stream sharing interface 800. The stream sharing interface 800 includes a content area 802, a distribution interface 804 and a share control 806. The content area 802 includes a content input area 808 and a content summary area 810. The content input area 808 can be used to input digital content and the content summary area 810 can display a summary of the search stream that is to be shared. In the illustrated example, the search stream that is to be shared includes the search stream 600 of FIGS. 6, 7A and 7B. In some examples, the content summary area 810 is pre-populated with a summary 812 of the search stream 600. In the illustrated example, the summary 812 comprises a thumbnail image 814, a title associated with the search stream and a brief description 818 of the search stream. The content input area 808 provides an interface with which the user can interact to add textual comments regarding the search stream.

In some implementations, the brief description 818 can be a pre-stored summary of the search stream. In some examples, user activation (e.g., clicking on) the stream sharing control 668 initiates a call to a data source. In some implementations, a pre-stored summary of the article is provided in response to the request. In some implementations, a summary is generated and the summary is returned for display as the brief description 818. In some examples, a summary can be generated using a script that crawls items associated with the search stream, that identifies data (e.g., text, images) within the items and that generates the summary based thereon. In some examples, a summary can be generated by one or more server systems that have access to the items in response to a request (e.g., a request that is automatically generated and transmitted in response to user action on the stream sharing control 668).

The user can define a distribution for the item that is to be generated for sharing the search stream using the distribution interface 804. Operation of the distribution interface 804 is similar to the operation of the distribution interface 740, discussed in detail above. Once the user is satisfied with the digital content to be included in the item, the user can initiate generation and distribution of the item by activating (e.g., clicking on) the share control 806. In response to user activation of the share control 806, the item is generated and includes digital content (e.g., textual user comment, search stream summary), and the item is distributed to other users of the social networking surface defined in the distribution.

In some implementations, and in response to the user sharing the search stream, a notification is generated and is displayed to users viewing the search stream, including the user that shared the search stream. The notification indicates that that particular user shared the search stream. In some examples, the notification includes a thumbnail image associated with the sharing user and/or other identifying information (e.g., a user name), as well as a message indicating that the sharing user shared the search stream. In some examples, a link can be provided to enable a user to click on the notification to access further information regarding the sharing user. For example, the thumbnail image and/or the user name can be associated with a hyperlink to a profile page of the sharing user within the social networking service.

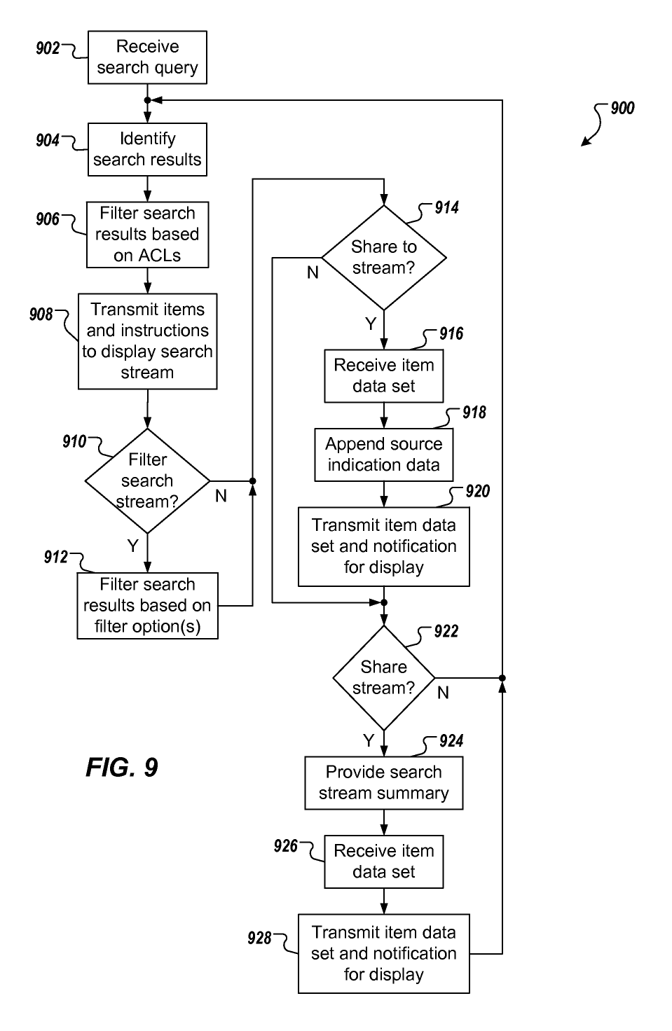

FIG. 9 is a flowchart of an example process 900 that can be executed in implementations of the present disclosure. In some implementations, the example process 900 can include operations that are performed using one or more computer programs executed using one or more data processing apparatus (e.g., one or more client-side computing devices and/or one or more server-side computing devices). The example process 900 can be executed to display a search stream and facilitate user sharing to and/or of the search stream.

A search query is received (902). The search query is processed (e.g., using a computer-implemented search engine) and search results are identified (904). The search results include items that have been distributed using a social networking service. The search results are filtered based on ACLs associated therewith (906) and items and instructions are transmitted to display the search stream (908). For example, a user ID associated with the user that submitted the search query is cross-referenced with the ACL of each item in the search results to determine whether the user is allowed access to the item. If the user is allowed access to the item, the item is included in the displayed search stream. If the user is not allowed access to the item, the item is not included in the displayed search stream.

It is determined whether the search stream is to be filtered (910). In some examples, a user viewing the search stream can interact with one or more filters (e.g., using filter controls 610, 612, 614 of FIG. 6) to filter the items that are displayed in the search stream. If the search stream is to be filtered the items provided in the search results are filtered based on one or more filter options and the filtered search stream is displayed (912). For example, filter options provided with a content filter control can include items that were directly shared to the search stream. In some examples, when the user selects a directly shared filter option, the search stream is filtered to only display items that were shared directly to the search stream by users.

It is determined whether the user is sharing an item to the search stream (914). For example, and as discussed in detail above, a user can interact with a content sharing interface (e.g., the content sharing interface 410 of FIG. 4) to share an item directly to the search stream. If the user is sharing an item to the search stream, an item data set is generated and received (916). Source indication data is appended to the item data set (918). In some example, the source indication data indicates that the item was shared directly to the particular search stream. The item data set and a notification are transmitted for display (920). In some examples, the item data set is distributed to users defined in the distribution associated with the item and that are viewing the search stream. In some examples, the notification is distributed to users defined in the distribution associated with the item to notify viewers of the search stream that the user shared an item to the search stream.

It is determined whether the user is sharing the search stream (922). For example, and as discussed in detail above, a user can interact with a stream sharing control (e.g., the stream sharing control 668 of FIG. 6) to share the search stream with other users of the social networking service. If the user is sharing the search stream, a search stream summary is provided to the user (e.g., within the search stream sharing interface 800 of FIG. 8). An item data set is generated and is received (926). The item data set and a notification are transmitted for display (920). In some examples, the item data set is distributed to users defined in the distribution associated with the item. In some examples, the notification is distributed to users defined in the distribution associated with the item to notify viewers of the search stream that the user shared the search stream.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

Implementations of the present disclosure and all of the functional operations provided herein can be realized in digital electronic circuitry, or in computer software, firmware, or hardware, including the structures disclosed in this specification and their structural equivalents, or in combinations of one or more of them. Implementations of the invention can be realized as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclose can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations of the invention can be realized in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this disclosure contains many specifics, these should not be construed as limitations on the scope of the disclosure or of what may be claimed, but rather as descriptions of features specific to particular implementations of the disclosure. Certain features that are described in this disclosure in the context of separate implementations can also be provided in combination in a single implementation. Conversely, various features that are described in the context of a single implementation can also be provided in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the present disclosure have been described. Other implementations are within the scope of the following claims. For example, the actions recited in the claims can be performed in a different order and still achieve desirable results.

What is claimed is:

1. A system comprising:
a computing device; and
a computer-readable medium coupled to the computing device and having instructions stored thereon which, when executed by the computing device, cause the computing device to perform operations comprising:
receiving a query for content within a user interface of a social networking service;
obtaining search results based on the query, the search results comprising a set of items distributed by users of the social networking service;
transmitting instructions to display the search results in a search stream provided in the user interface, the set of items being included in the search stream;
receiving first user input, the first user input defining an item data set associated with an item to be provided in the search results; and
transmitting instructions to display revised search results including the item in one or more search streams, the one or more search streams including the search stream.

2. The system of claim 1, wherein operations further comprise providing source indication data in the item data set, the source indication data indicating that the item was shared directly to the search stream.

3. The system of claim 2, wherein operations further comprise:
receiving a second query for content;
generating second search results based on the second query, the search results identifying the set of items distributed by users of the social networking service;
determining, based on the source indication data, that the item is to be included in the second search results; and
transmitting instructions to display the second search results in the search stream, the set of items and the item being included in the search stream.

4. The system of claim 1, wherein generating search results based on the query comprises:
identifying a first set of items based on the query;
for each item in the first set of items, determining whether a user that submitted the query is authorized access; and
identifying a second set of items, the second set of items including the set of items, the user being authorized access to each item of the set of items, the search results comprising the second set of items.

5. The system of claim 4, wherein, for each item in the first set of items, determining whether the user that submitted the query is authorized access comprises, for each item in the first set of items, determining whether the user is identified in an associated access control list (ACL).

6. The system of claim 1, wherein the search stream is displayed to a user that submitted the query, and transmitting instructions to display revised search results including the item in one or more search streams comprises displaying the revised search results in a second search stream associated with a second user.

7. The system of claim 1, wherein the revised search results are provided in real-time without requiring a user request for the revised search results.

8. The system of claim 1, wherein operations further comprise:
receiving second user input, the second user input defining a filter option for filtering items displayed in the search stream, the filter option indicating a request to display items in the search stream that had been shared directly to the search stream; and
in response to the second user input, transmitting instructions to display revised search results in the search stream, the revised search results comprising items that had been shared directly to the search stream.

9. The system of claim 8, wherein the items that had been shared directly to the search stream comprise the item that had been shared by a user that provided the first user input.

10. The system of claim 8, wherein the items that had been shared directly to the search stream comprise items that had been shared by one or more users of the social networking service.

11. The system of claim 1, wherein operations further comprise transmitting instructions to display a notification in the one or more search streams, the notification providing an indication of a user that provided the first user input.

12. Computer storage media encoded with one or more computer programs, the one or more computer programs comprising instructions that when executed by data processing apparatus cause the data processing apparatus to perform operations comprising:
receiving a query for content within a user interface of a social networking service;
obtaining search results based on the query, the search results comprising a set of items distributed by users of the social networking service;
transmitting instructions to display the search results in a search stream provided in the user interface, the set of items being included in the search stream;
receiving first user input, the first user input defining an item data set associated with an item to be provided in the search results; and
transmitting instructions to display revised search results including the item in one or more search streams, the one or more search streams including the search stream.

13. The computer storage media of claim 12, wherein operations further comprise providing source indication data in the item data set, the source indication data indicating that the item was shared directly to the search stream.

14. The computer storage media of claim 13, wherein operations further comprise:
receiving a second query for content;
generating second search results based on the second query, the search results identifying the set of items distributed by users of the social networking service;
determining, based on the source indication data, that the item is to be included in the second search results; and
transmitting instructions to display the second search results in the search stream, the set of items and the item being included in the search stream.

15. The computer storage media of claim 12, wherein generating search results based on the query comprises:
identifying a first set of items based on the query;
for each item in the first set of items, determining whether a user that submitted the query is authorized access; and
identifying a second set of items, the second set of items including the set of items, the user being authorized access to each item of the set of items, the search results comprising the second set of items.

16. The computer storage media of claim 12, wherein the search stream is displayed to a user that submitted the query, and transmitting instructions to display revised search results including the item in one or more search streams comprises displaying the revised search results in a second search stream associated with a second user.

17. The computer storage media of claim 12, wherein operations further comprise:
receiving second user input, the second user input defining a filter option for filtering items displayed in the search stream, the filter option indicating a request to display items in the search stream that had been shared directly to the search stream; and
in response to the second user input, transmitting instructions to display revised search results in the search stream, the revised search results comprising items that had been shared directly to the search stream.

18. The computer storage media of claim 17, wherein the items that had been shared directly to the search stream comprise the item that had been shared by a user that provided the first user input.

19. The computer storage media of claim 17, wherein the items that had been shared directly to the search stream comprise items that had been shared by one or more users of the social networking service.

20. The computer storage media of claim 12, wherein operations further comprise transmitting instructions to display a notification in the one or more search streams, the notification providing an indication of a user that provided the first user input.

21. A computer-implemented method executed using one or more processors, the method comprising:
receiving, by the one or more processors, a query for content within a user interface of a social networking service;
obtaining, by the one or more processors, search results based on the query, the search results comprising a set of items distributed by users of the social networking service;
transmitting, by the one or more processors, instructions to display the search results in a search stream provided in the user interface, the set of items being included in the search stream;
receiving, by the one or more processors, first user input, the first user input defining an item data set associated with an item to be provided in the search results; and
transmitting, by the one or more processors, instructions to display revised search results including the item in one or more search streams, the one or more search streams including the search stream.

22. The method of claim 21, further comprising providing source indication data in the item data set, the source indication data indicating that the item was shared directly to the search stream.

23. The method of claim 22, further comprising:
receiving a second query for content;
generating second search results based on the second query, the search results identifying the set of items distributed by users of the social networking service;
determining, based on the source indication data, that the item is to be included in the second search results; and
transmitting instructions to display the second search results in the search stream, the set of items and the item being included in the search stream.

24. The method of claim 21, wherein generating search results based on the query comprises:
identifying a first set of items based on the query;
for each item in the first set of items, determining whether a user that submitted the query is authorized access; and
identifying a second set of items, the second set of items including the set of items, the user being authorized access to each item of the set of items, the search results comprising the second set of items.

25. The method of claim 21, wherein the search stream is displayed to a user that submitted the query, and transmitting instructions to display revised search results including the item in one or more search streams comprises displaying the revised search results in a second search stream associated with a second user.

26. The method of claim 21, further comprising:
receiving second user input, the second user input defining a filter option for filtering items displayed in the search stream, the filter option indicating a request to display items in the search stream that had been shared directly to the search stream; and
in response to the second user input, transmitting instructions to display revised search results in the search stream, the revised search results comprising items that had been shared directly to the search stream.

27. The method of claim 26, wherein the items that had been shared directly to the search stream comprise the item that had been shared by a user that provided the first user input.

28. The method of claim 26, wherein the items that had been shared directly to the search stream comprise items that had been shared by one or more users of the social networking service.

29. The method of claim 21, further comprising transmitting instructions to display a notification in the one or more search streams, the notification providing an indication of a user that provided the first user input.
